(19) United States
(12) Patent Application Publication
(10) Pub. No.: US 2014/0315443 A1
(43) Pub. Date: Oct. 23, 2014

(54) SOCKET

(71) Applicant: HSING CHAU INDUSTRIAL CO., LTD., TAIPEI CITY (TW)

(72) Inventor: CHIEN-LIANG LIN, TAIPEI CITY (TW)

(73) Assignee: HSING CHAU INDUSTRIAL CO., LTD., TAIPEI CITY (TW)

(21) Appl. No.: 13/867,390

(22) Filed: Apr. 22, 2013

(51) Int. Cl. H01R 25/00; H01R 27/02

(52) U.S. Cl. CPC H01R 25/006; H01R 27/02
USPC 439/638

(57) ABSTRACT

A socket includes a casing, a circuit board, a first connector, and a second connector. The casing has a first jack and a second jack. The circuit board is disposed in the casing. The first and second connectors are disposed on the circuit board. The first connector has a first slot corresponding in position to the first jack. The external plug is moved along a first extension line and inserted into the first slot. The second connector has a second slot corresponding in position to the second jack. The external plug is moved along a second extension line and inserted into the second slot. The first and second extension lines are not parallel. With the jacks corresponding in position to the slots, respectively, space required for accommodating external plugs and transmission lines thereof is reduced or properly arranged; hence, the socket is fit for use in layout in crowded places.

### FIELD OF TECHNOLOGY

The present invention relates to sockets, and more particularly, to a socket for admitting a plug, extending a transmission distance, and switching to a different transmission interface.

### BACKGROUND

Referring to FIG. 1, a conventional socket 200 essentially comprises a casing 210, a circuit board 220, a front connector 230 and a rear connector 240. The casing 210 has a front end and a rear end. A front jack 211 is disposed at the front end of the casing 210. A rear jack 212 is disposed at the rear end of the casing 210. The front jack 211 and the rear jack 212 are in communication with the front connector 230 and the rear connector 240 of the casing 210, respectively. The front connector 230 and the rear connector 240 have the same transmission interface. Alternatively, the front connector 230 and the rear connector 240 have different transmission interfaces. The conventional socket 200 admits a plug, extends a transmission distance, and switches to a different transmission interface.

At least one said conventional socket 200 is disposed on a casing of an electronic device, such as a computer or a host computer, such that external plugs of different computers or host computers can be plugged into the at least one said conventional socket 200 to thereby connect the computers or host computers together. Alternatively, at least one said conventional socket 200 is coupled to a jack of a socket panel (for example, a keystone wall plate) and fixed to the wall; hence, an electronic device can be connected to an indoor data communication network, if an external plug of the electronic device is plugged into the at least one said conventional socket 200. Accordingly, the conventional sockets 200 are widely used in indoor local area networks and cable TV networks.

Since the front jack 211 and the rear jack 212 of the conventional socket 200 are disposed at the front and rear ends of the conventional socket 200, respectively, the external plugs of the electronic devices are plugged into the front jack 211 and the rear jack 212 of the conventional socket 200, respectively. As a result, the front and rear ends of the conventional socket 200 have to provide the space required for accommodating the external plugs and transmission lines thereof, thereby hindering the installation of the conventional sockets 200 in small host computers or a crowded venue.

### SUMMARY

In view of the aforesaid drawbacks of the prior art, it is an objective of the present invention to provide a socket characterized in that a jack on a socket casing corresponds in position to a built-in connector slot, such that the space required for accommodating external plugs and transmission lines thereof is reduced or properly arranged, and thus the socket is fit for use in layout in a crowded place.

In order to achieve the above and other objectives, the present invention provides a socket, comprising: a casing having a first jack and a second jack; a circuit board disposed in the casing; a first connector disposed on the circuit board and having a first slot corresponding in position to the first jack, the first slot allowing an external plug to be moved along a first extension line and inserted into the first slot; and a second connector disposed on the circuit board, electrically connected to the first connector, and having a second slot corresponding in position to the second jack, the second slot allowing another external plug to be moved along a second extension line and inserted into the second slot, wherein the second extension line and the first extension line are not parallel to each other.

In an embodiment, the second extension line and the first extension line are perpendicular to each other.

In an embodiment, the casing comprises a first case and a second case which are coupled together to define a receiving space for receiving the circuit board.

In an embodiment, the first case and the second case are jointed and coupled together by ultrasonic welding.

In an embodiment, the first connector has a transmission interface, including USB (Universal Serial Bus), HDMI (High-Definition Multimedia Interface), DisplayPort, Thunderbolt, AVI (Audio Video Interleave), or TRS (Tip-Ring-Sleeve).

In an embodiment, the second connector has a transmission interface, including USB (Universal Serial Bus), HDMI (High-Definition Multimedia Interface), DisplayPort, Thunderbolt, AVI (Audio Video Interleave), or TRS (Tip-Ring-Sleeve).

Hence, a socket of the present invention is characterized in that a jack on a socket casing corresponds in position to a built-in connector slot, such that the space required for accommodating external plugs and transmission lines thereof is reduced or properly arranged, and thus the socket is fit for use in layout in a crowded place, and is capable of extending, expanding, and switching. Furthermore, the socket of the present invention comes with various transmission interfaces, such that users find it convenient to install or uninstall different transmission interfaces on a socket panel and change them, thereby achieving modularized design.

### BRIEF DESCRIPTION OF THE DRAWINGS

Objectives, features, and advantages of the present invention are hereunder illustrated with specific embodiments in conjunction with the accompanying drawings, in which:

FIG. 1 (PRIOR ART) is a schematic view of a conventional connector;

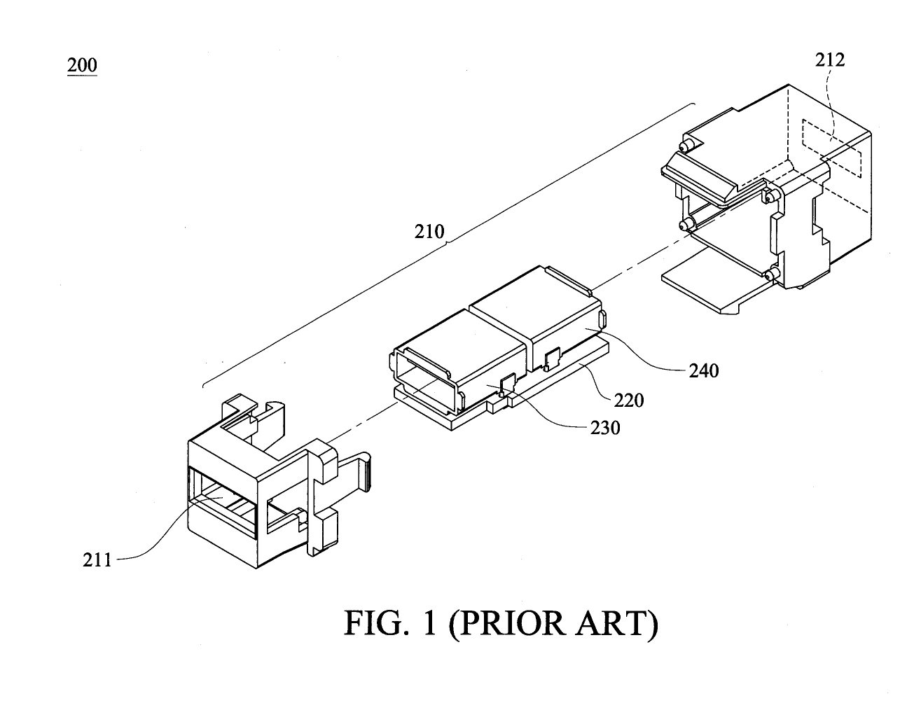

FIG. 2 is an exploded view of a socket according to an embodiment of the present invention;

FIG. 3 is a schematic view of the socket assembled according to an embodiment of the present invention; and

FIG. 4 is a schematic view of the socket mounted on a socket panel and operating according to an embodiment of the present invention.

### DETAILED DESCRIPTION

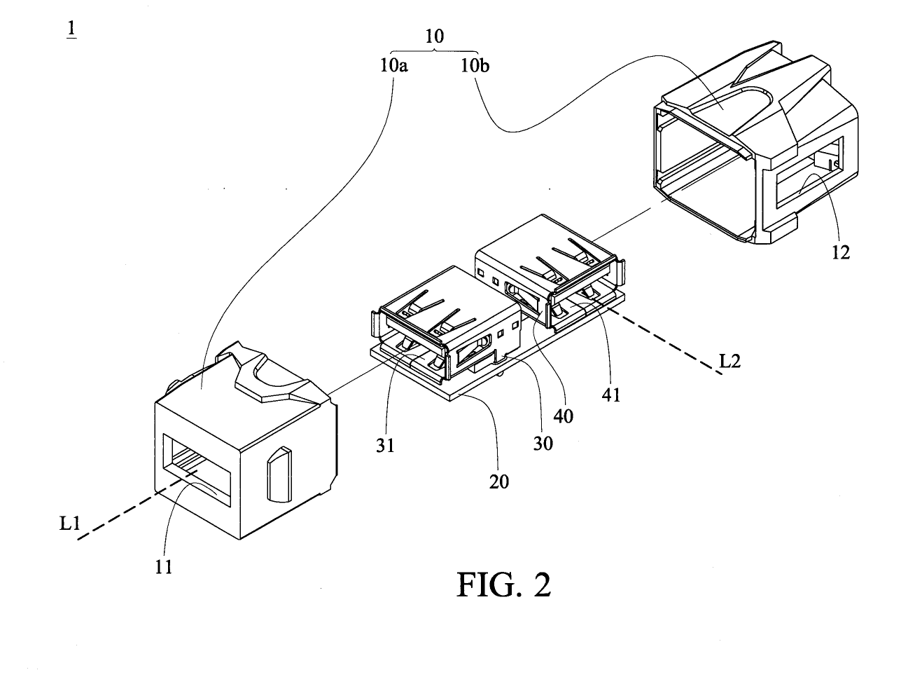

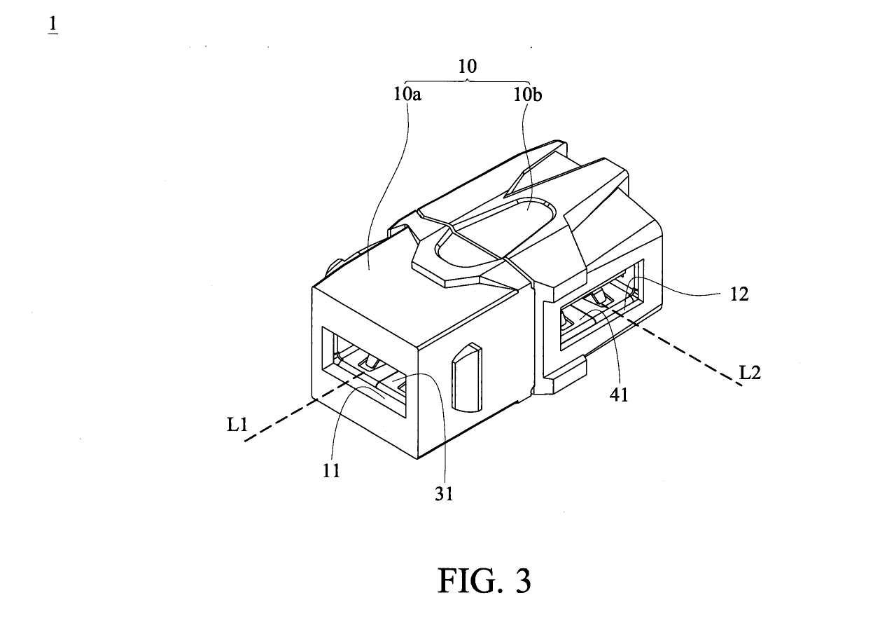

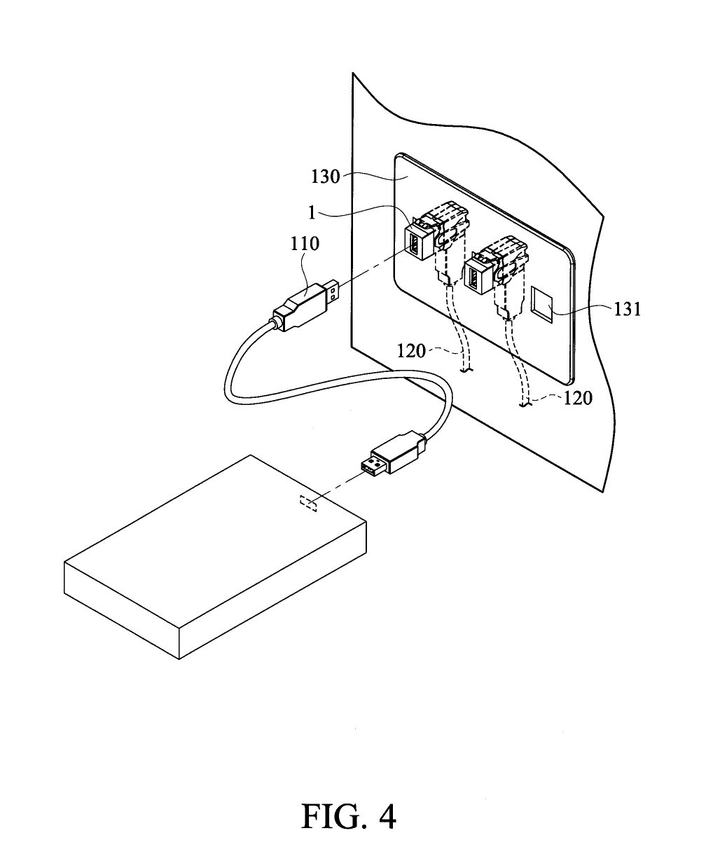

Referring to FIG. 2 and FIG. 3, there are shown an exploded view and a schematic view of a socket 1 according to an embodiment of the present invention. In an embodiment of the present invention, the socket 1 essentially comprises a casing 10, a circuit board 20, a first connector 30, and a second connector 40. The casing 10 has a first jack 11 and a second jack 12. The circuit board 20 is disposed in the casing 10. The first connector 30 is disposed on the circuit board 20 and has a first slot 31. The first slot 31 corresponds in position to the first jack 11 and enables an external plug 110 (see FIG. 4) to be moved along a first extension line L1 and inserted into the first slot 31. The second connector 40 is disposed on the circuit board 20 and electrically connected to the first connector 30. The second connector 40 has a second slot 41 corresponding in position to the second jack 12. The second slot 41 enables another external plug 120 (see FIG. 4) to be moved along a second extension line L2 and inserted into the second slot 41. The second extension line L2 and the first extension line L1 are not parallel to each other.

Referring to FIG. 3 and FIG. 4, regarding the socket 1 in an embodiment of the present invention, the first extension line L1 is not only perpendicular to an imaginary plane (not shown) defined by the brim of the opening of the first slot 31 of the first connector 30, but also perpendicular to an imaginary plane (not shown) defined by the brim of the opening of the first jack 11 of the casing 10. The external plug 110 is moved along the first extension line L1, through the first jack 11, and inserted into the first slot 31, so as to be connected to the first connector 30. The second extension line L2 is not only perpendicular to an imaginary plane (not shown) defined by the brim of the opening of the second slot 41 of the second connector 40, but also perpendicular to an imaginary plane (not shown) defined by the brim of the opening of the second jack 12 of the casing 10. The external plug 120 is moved along the second extension line L2, through the second jack 12, and inserted into the second slot 41, so as to be connected to the second connector 40. The second extension line L2 and the first extension line L1 are not parallel to each other. That is to say, the included angle between the second extension line L2 and the first extension line L1 is larger than 0 degrees but less than 180 degrees, or, when put in plain language, is an acute angle, a right angle, or an obtuse angle. Referring to FIG. 4, it is also feasible that the first slot 31 of the first connector 30 and the second slot 41 of the second connector 40 are not disposed at two opposing ends of the socket 1, respectively, such that the transmission lines connected with the external plugs 110, 120 of the socket 1 do not concurrently occupy the space in the vicinity of the front end and the space in the vicinity of the rear end of the socket or vice versa. Hence, the socket 1 can be conveniently applied to the layout of a crowded place.

In a preferred embodiment of the present invention, the second extension line L2 and the first extension line L1 are perpendicular to each other, and thus an imaginary plane (not shown) defined by the brim of the opening of the first slot 31 of the first connector 30 is perpendicular to an imaginary plane (not shown) defined by the brim of the opening of the second slot 41 of the second connector 40, whereas an imaginary plane (not shown) on which the first jack 11 lies is perpendicular to an imaginary plane (not shown) on which the second jack 12 lies. Hence, when the socket 1 is installed in a crowded place, the transmission line of the external plug 120 inserted into the second slot 41 runs perpendicularly to the direction in which the external plug 110 is inserted into the first slot 31. Referring to FIG. 4, not only is the external plug 120 of the second slot 41 oriented in a “hung downward” manner, but its transmission line also runs parallel to the wall surface, such that the transmission line does not occupy the space in the vicinity of the rear end of the socket 1.

In this embodiment, the casing 10 comprises a first case 10a and a second case 10b. The first case 10a and the second case 10b are coupled together to define a receiving space. The circuit board 20 is received in the receiving space thus defined. Referring to FIG. 2 and FIG. 3, the first case 10a and the second case 10b are jointed and coupled together by ultrasonic welding to achieve a hermetic seal, so as to define the receiving space.

In this embodiment, referring to FIG. 2 through FIG. 4, the first case 10a has the first jack 11, wherein the front end of the first case 10a corresponds in shape to a jack 131 of a socket panel 130 (as shown in FIG. 4), such that the socket 1 can be plugged into the jack 131 of the socket panel 130. Furthermore, the jacks 131 of the socket panel 130 can be provided in plurality to operate in conjunction with multiple said sockets 1, respectively.

The first connector 30 has a transmission interface, including USB (Universal Serial Bus), HDMI (High-Definition Multimedia Interface), DisplayPort, Thunderbolt, AVI (Audio Video Interleave), or TRS (Tip-Ring-Sleeve). The second connector 40 has a transmission interface, including USB (Universal Serial Bus), HDMI (High-Definition Multimedia Interface), DisplayPort, Thunderbolt, AVI (Audio Video Interleave), or TRS (Tip-Ring-Sleeve). Hence, the socket 1 comes with various transmission interfaces to not only allow users to plug at least one said socket 1 into at least one said jack 131 of the socket panel 130, respectively, in a manner that meets the requirement for the type and quantity of the transmission interfaces, but also allow users to change, install or uninstall the socket 1 with various transmission interfaces as needed, thereby achieving socket and socket panel modularization.

The aforesaid USB-based transmission interface complies with specifications, including USB 2.0, USB 3.0, Mini-USB, and Micro-USB. The first connector 30 and the second connector 40 of the socket 1 of the present invention are not restricted to the aforesaid transmission interfaces, but can also go with other types of transmission interfaces, such as audio transmission interfaces, video transmission interfaces, and video-audio transmission interfaces.

In this embodiment, the first connector 30 and the second connector 40 are exemplified by a USB-based transmission interface. The external plugs 110, 120 with a USB-based transmission interface are inserted into the first connector 30 and the second connector 40. The transmission interface of the first connector 30 and the transmission interface of the second connector 40 are either identical or different. If the transmission interface of the first connector 30 and the transmission interface of the second connector 40 are identical, the socket 1 will be capable of extending the transmission distance. If the transmission interface of the first connector 30 and the transmission interface of the second connector 40 are different, the socket 1 will be capable of expanding and switching. Furthermore, in an embodiment of the present invention, the socket 1 is mounted on the socket panel 130 in order to operate; however, the present invention is not limited thereto. In practice, it is also feasible for the socket 1 to operate independently and still be capable of extending, expanding, and switching.

Hence, in an embodiment of the present invention, a socket is characterized in that a jack on a socket casing corresponds in position to a built-in connector slot, such that the space required for accommodating external plugs and transmission lines thereof is reduced or properly arranged, and thus the socket is fit for use in layout in a crowded place and is capable of extending, expanding, and switching. Furthermore, in an embodiment of the present invention, a socket can come with different transmission interfaces to thereby enable users to install, uninstall, and change the transmission interfaces of the socket mounted on the socket panel, thereby enabling modularized design.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A socket, comprising:
a casing having a first jack and a second jack;
a circuit board disposed in the casing;
a first connector disposed on the circuit board and having a first slot corresponding in position to the first jack, the first slot allowing an external plug to be moved along a first extension line and inserted into the first slot; and
a second connector disposed on the circuit board, electrically connected to the first connector, and having a second slot corresponding in position to the second jack, the second slot allowing another external plug to be moved along a second extension line and inserted into the second slot, wherein the second extension line and the first extension line are not parallel to each other.

2. The socket of claim 1, wherein the second extension line and the first extension line are perpendicular to each other.

3. The socket of claim 1, wherein the casing comprises a first case and a second case which are coupled together to define a receiving space for receiving the circuit board.

4. The socket of claim 3, wherein the first case and the second case are jointed and coupled together by ultrasonic welding.

5. The socket of claim 1, wherein the first connector has a transmission interface selected from the group consisting of USB (Universal Serial Bus), HDMI (High-Definition Multimedia Interface), DisplayPort, Thunderbolt, AVI (Audio Video Interleave), and TRS (Tip-Ring-Sleeve).

6. The socket of claim 5, wherein the second connector has a transmission interface selected from the group consisting of USB (Universal Serial Bus), HDMI (High-Definition Multimedia Interface), DisplayPort, Thunderbolt, AVI (Audio Video Interleave), and TRS (Tip-Ring-Sleeve).
